(19) United States
(12) Patent Application Publication
(10) Pub. No.: US 2022/0249882 A1
(43) Pub. Date: Aug. 11, 2022

(54) Construction Hard Hat With Integrated Air Circulation, Camera, Display and Face Mask

(71) Applicant: Artistexture LLC, New Providence, NJ (US)

(72) Inventor: Stephen M. Sannicandro, New Providence, NJ (US)

(73) Assignee: Artistexture LLC, New Providence, NJ (US)

(21) Appl. No.: 17/484,650

(22) Filed: Sep. 24, 2021

Related U.S. Application Data
(60) Provisional application No. 63/148,416, filed on Feb. 11, 2021.

(51) Int. Cl. A62B 18/04; A42B 3/14; A42B 3/04; A62B 23/00; G08B 5/36

(52) U.S. Cl. CPC A62B 18/045; A42B 3/14; G08B 5/36; A62B 23/00; A42B 3/042

(57) ABSTRACT

A hard hat style helmet includes a powered and filtered air intake and distribution system. The air distribution system directs filtered air into a breathing mask structured and located to cover a wearer's mouth and nose. The helmet includes wireless telecommunication features and a speaker and microphone to enable hands-free voice calling. The helmet also includes a camera for transmitting the wearer's field of view. The helmet also includes a transparent display inside the wearer's field of view and another display outside the wearer's field of view.

### CROSS-REFERENCE TO RELATED APPLICATIONS

This application claims the benefit of the filing date of U.S. Provisional Patent Application No. 63/148,416 filed Feb. 11, 2021, the disclosure of which is hereby incorporated herein by reference.

### BACKGROUND

Construction or industrial worksites frequently require on-site workers to wear personal protective equipment including head protection such as hard hats or helmets. Many hard hats adhere to designs that have changed little over several decades. As such, typical hard hats tend to trap hot air and usually do not protect wearers from airborne hazards, such as chemical fumes or aerosolized pathogens. Communication on worksites is usually accomplished with cellular phones that must be held in workers' hands or headsets that can be cumbersome and uncomfortable to wear at the same time as a hard hat. Transmission of video or images across a worksite or to remote collaborators is most commonly accomplished with cameras or smart phones that also require use of a worker's hands. Equipment that can improve the air quality and circulation available to a wearer or facilitate telecommunication is therefore needed.

### BRIEF SUMMARY

In one aspect, a hard hat style helmet may include electronic systems for either or both of additional protection of the wearer and facilitating cross-worksite or inter-worksite communication. The helmet may include a powered air intake and distribution system. The air distribution system may be filtered. The air distribution system may direct the filtered air into a breathing mask. The breathing mask may be modularly connectable to and disconnectable from the helmet. The air distribution system may be configured to only send air to the user through the breathing mask, leaving the inner shell of the helmet free of holes. Alternatively, the air distribution system may send the filtered air through a dome of the helmet toward a wearer for cooling. In either case, the air distribution system may take outside fresh air and filter it through a conduit that runs from the top of the helmet to a discharge location at each side of the helmet through which the air passes a respective mask connector conduit.

The helmet may include wireless telecommunication hardware. The helmet may also include a speaker and microphone, such as in the form of a modularly connectable and disconnectable headset, for use with the telecommunication hardware to enable hands-free voice calling to on-site and remote co-workers. The helmet may also include a front facing camera for either or both of recording and transmitting at least part of the wearer's field of view. The helmet may also include display hardware for displaying information related to any one or any combination of work related instructions for the wearer, settings of the helmet, status of the helmet, or selectable functions for the helmet. The display hardware may include either or both of a display inside the wearer's field of view and a display outside the wearer's field of view. The display inside the wearer's field of view may be capable of being added or removed at the wearer's discretion. At least the display inside the wearer's field of view may be a transparent display. At least the display inside the wearer's field of view may be modularly connectable to and disconnectable from the dome of the helmet.

In another aspect, a helmet may comprise a dome including an outer shell to which a front facing camera is mounted, a modular heads up display (“HUD”) lens removably connectable to the dome, a microphone and a speaker connected to the dome, wireless telecommunication hardware housed within the dome, and a breathing mask.

In another arrangement according to any of the foregoing, the microphone and speaker may be part of a headset removably connectable to the helmet at a jack of the dome.

In another arrangement according to any of the foregoing, the dome may include an outer shell and an inner shell received within and fastened to the outer shell.

In another arrangement according to any of the foregoing, the HUD lens may be a transparent display.

In another arrangement according to any of the foregoing, the helmet may comprise a screen located on a portion of the dome outside of an area corresponding to a field of view of a wearer of the helmet.

In another arrangement according to any of the foregoing, the screen may be located at a rear facing position on the dome.

In another arrangement according to any of the foregoing, the screen may be a touch screen.

In another arrangement according to any of the foregoing, the helmet may comprise haptic feedback hardware governed to activate in response to inputs to the screen.

In another arrangement according to any of the foregoing, the helmet may comprise an air distribution system extending within the dome and including a powered air intake defined at an opening in the dome.

In another arrangement according to any of the foregoing, the air distribution system may include an air filter extending across an air flow path of the air distribution system.

In another arrangement according to any of the foregoing, the helmet may comprise a breathing mask including a face covering portion behind which a space is defined and airways connectable to the dome to establish fluid communication between the air distribution system and the space behind the face covering portion.

In another arrangement according to any of the foregoing, the breathing mask may be reversibly disconnectable from the dome.

In another arrangement according to any of the foregoing, the face covering portion of the mask may include a one way valve permitting air flow out of the space behind the face covering portion.

In another aspect, a helmet may comprise a dome, an air distribution system extending within the dome and including a powered air intake defined at an opening in the dome, and a breathing mask including a face covering portion behind which a space is defined and airways releasably connectable to the dome to establish fluid communication between the air distribution system and the space behind the face covering portion.

In another arrangement according to any of the foregoing, the face covering portion of the mask may include a one way valve permitting air flow out of the space behind the face covering portion.

In another arrangement according to any of the foregoing, the helmet may comprise an adjustable suspension system for suspending the dome relative to a wearer's head and the dome may include a hard hat shell.

In another arrangement according to any of the foregoing, the helmet may comprise wireless telecommunication hardware, a speaker, and a microphone.

In another arrangement according to any of the foregoing, the helmet may comprise a front facing camera.

In another arrangement according to any of the foregoing, the helmet may comprise a transparent HUD lens extending from a point of connection to the dome into a space corresponding to a field of view of a wearer of the helmet.

In another arrangement according to any of the foregoing, the helmet may comprise a screen removably mounted to the dome outside of a space corresponding to a field of view of a wearer of the helmet.

In another arrangement according to any of the foregoing, the helmet may comprise lights on an exterior of the dome and a thermometer configured to measure a temperature of a wearer of the helmet. The lights may be controlled to display a warning signal when the measured temperature exceeds a predetermined threshold.

In another arrangement according to any of the foregoing, the air distribution system may include holes through an inner shell of the dome such that at least some air propelled through the air distribution system is directed toward an interior of the dome.

In another arrangement according to any of the foregoing, the mask may be releasably connectable to the dome at filtered outlet openings of the air distribution system.

In another arrangement according to any of the foregoing, the mask may include filtered inlet openings for connection to the air distribution system. The inlet openings may include an inner mesh covering to prevent any outside debris or material from entering and backing up the air distribution conduit.

In another arrangement according to any of the foregoing, the face covering portion of the mask may be rigid.

In another arrangement according to any of the foregoing, the face covering portion of the mask may be transparent.

In another arrangement according to any of the foregoing, the air intake may include a holder for holding a replaceable air filter spanning an airway of the air intake.

In another arrangement according to any of the foregoing, the holder may be upstream of an impeller included by the air intake.

In another arrangement according to any of the foregoing, the helmet may comprise a coarse filter upstream of the holder.

In another arrangement according to any of the foregoing, the coarse filter may be a lid extending across a majority of an opening in the dome through which the air intake is defined.

In another aspect, a helmet may comprise a dome including an outer shell and an inner shell that are connected to one another so as to enclose an enclosed space between the outer shell and the inner shell. The helmet may also comprise an air distribution system including air conduits extending in the enclosed space, the air distribution system being configured to draw air into the conduits from outside the dome and to expel air to the mask connection outlet. The helmet may also comprise a face mask connected to the dome.

In another arrangement according to any of the foregoing, the helmet may comprise lights on an exterior of the outer shell and a thermometer configured to measure a temperature of a wearer of the helmet. The lights may be controlled to display a warning signal when the measured temperature exceeds a predetermined threshold.

In another arrangement according to any of the foregoing, the air distribution system may be configured to draw air into the conduits through an intake defined through the outer shell and the inner shell and to expel air through openings in the inner shell.

In another arrangement according to any of the foregoing, the mask may include air conduits and is connected to the dome by releasable connections between the air conduits of the mask and the air conduits of the air distribution system.

In another arrangement according to any of the foregoing, the helmet may comprise a coarse air filter and a fine air filter for the air distribution system.

### BRIEF DESCRIPTION OF THE DRAWINGS

FIG. 1 is an oblique, upper-front perspective view of a helmet.

FIG. 2 is an oblique, lower-front perspective view of the helmet of FIG. 1.

FIG. 3 is an oblique, lower-rear perspective view of the helmet of FIG. 1.

FIG. 4A is an oblique, lower-front perspective view of a heads up display lens of the helmet of FIG. 1 spaced apart from an attachment bezel.

FIG. 4B is an oblique, upper-front perspective view of the lens of FIG. 4B.

FIG. 5 is an illustration of an exploded arrangement of structural components of the helmet of FIG. 1.

FIG. 6 is an oblique, upper-front, and partially broken away view of the helmet of FIG. 1.

FIG. 7 is an enlarged view of the area A of FIG. 6.

FIG. 8 is an oblique, upper-rear, and partially broken away view of the helmet of FIG. 1.

FIG. 9 is a flowchart of a possible order of assembly of the helmet of FIG. 1.

### DETAILED DESCRIPTION

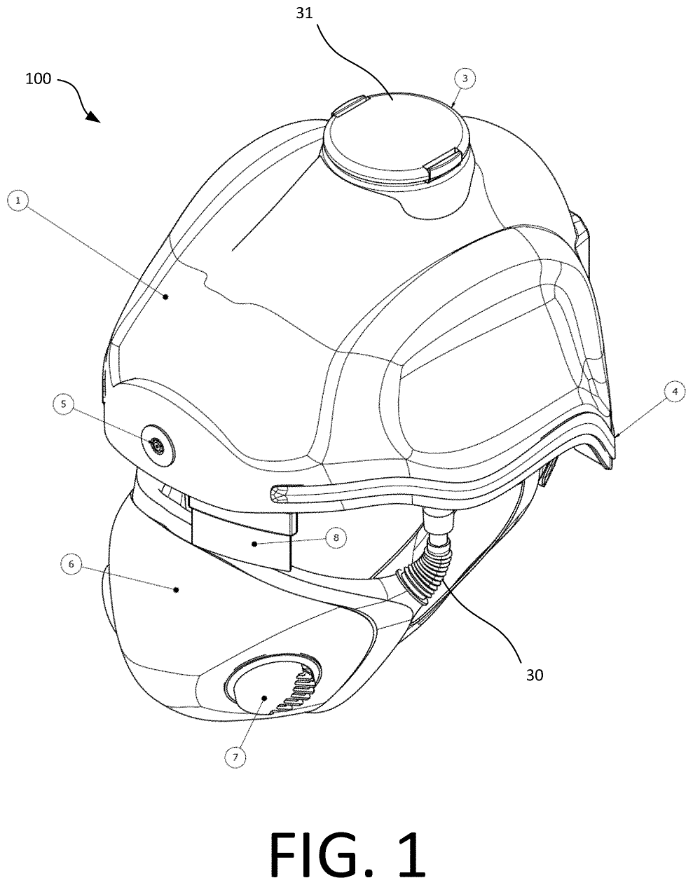

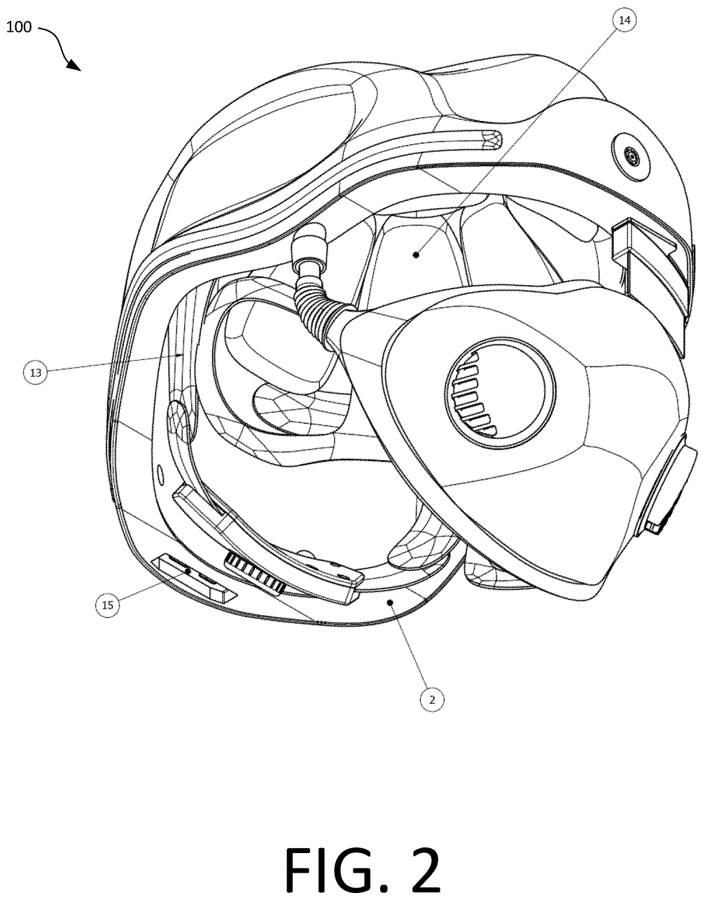

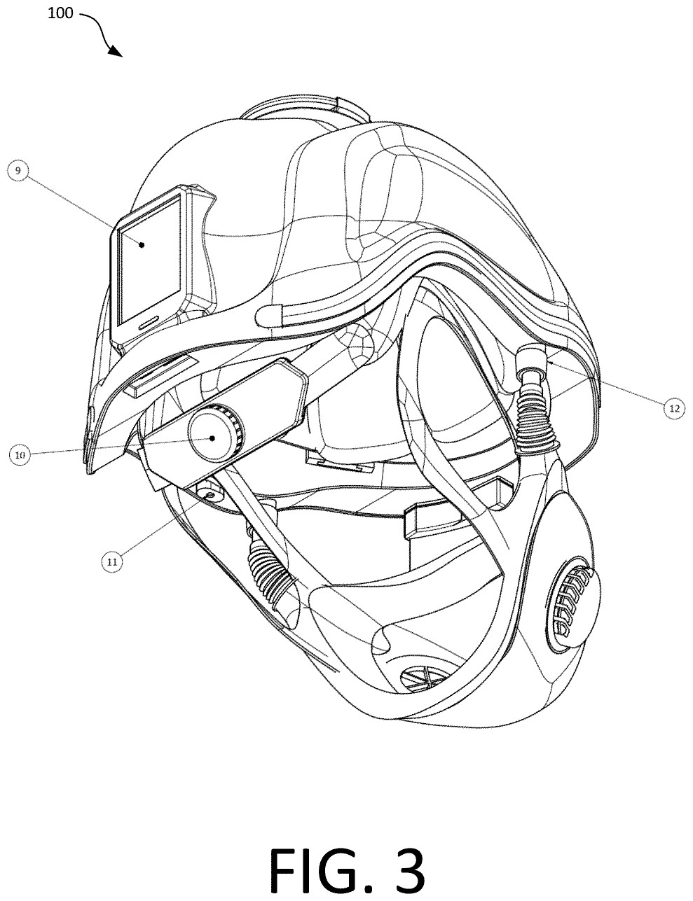

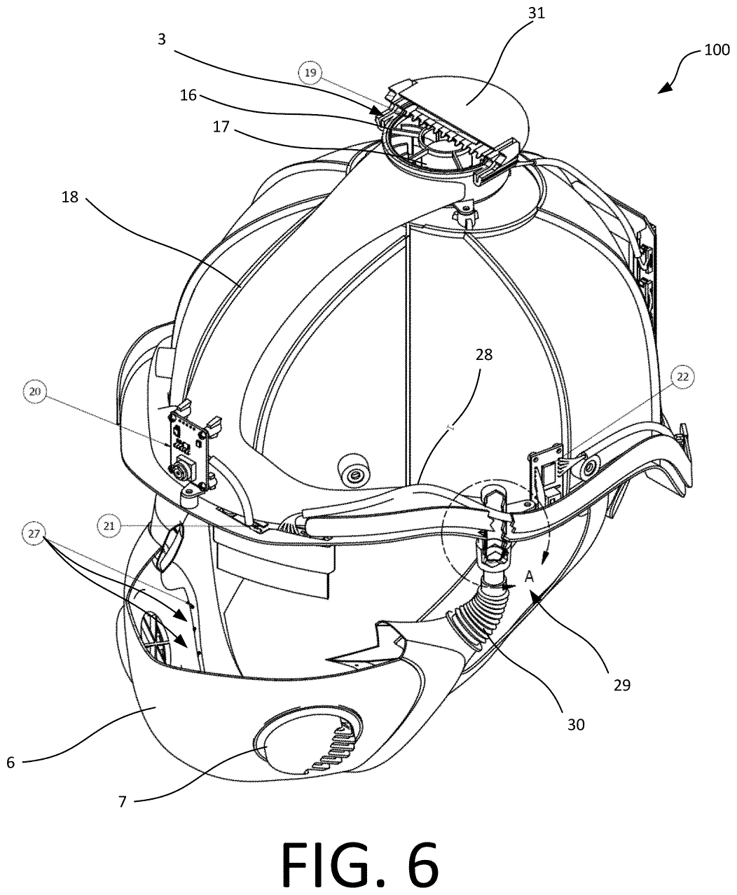

As shown in FIG. 1, a hard hat or helmet 100 includes an outer shell 1, which may be generally alike in material and structure to the shell of known helmets or hard hats except where specifically shown or stated, and several additional features. Such additional features of helmet 100 include an air distribution system including a powered air intake 3 in outer shell 1, light strips 4, a camera 5, a breathing mask 6, and a heads up display (“HUD”) lens 8. Further additional features include an inner shell 2, modular cushions 14, and connector ports 15 as shown in FIG. 2, a headphone jack 11 and screen 9 as shown in FIG. 3, a harness 28 as shown in FIG. 6, and an on-board processor and non-transitory computer readable memory medium, or other medium that stores data that may be read with the aid of an electronic device, such as a hard-drive, memory card, read-only memory (“ROM”), random access memory (“RAM”), optical disks, as well as other write-capable and read-only memories. Helmet 100 of the illustrated example includes all of these additional features, and useful interactions between some of such features are described below, but these features may be implemented individually or in any combination in helmets or hard hats according to alternative arrangements.

Helmet 100 includes an onboard processor governing multiple smart features of the helmet and, optionally, enabling telecommunication between the helmet and remote computers or networks by any suitable protocol, such as, for example, Wi-Fi, LTE, or Bluetooth. Any mention herein of functions that the processor may be configured to perform refers to storage of instructions on the memory that, when read by the processor, would cause the processor to perform those functions. Moreover, any processor mentioned herein may either be a single processing unit or multiple units in cooperation. Smart features include a camera 5 on a front facing part of helmet 100 and heads up display lens 8 positioned for easy reference by a wearer, as shown in FIG. 1, and screen 9 as shown in FIG. 3. The processor may govern light strips 4 according to measurements acquired from a thermometer, not illustrated, positioned to measure the wearer's body temperature. Any type of thermometer may be used for this purpose, but in one example the thermometer may be a contact thermometer located on helmet 100 so as to contact the wearer's skin. Light strips 4 may be governed to shine a different color or blink a warning pattern if the wearer's temperature is found to be outside of a healthy range. For example, light strips 4 may be governed to warn observers that the wearer's temperature is indicative of illness, fever, or overheating. In some examples, tight strips 4 may be unilluminated or may shine a white or blue color outside of warning conditions, and light strips 4 may shine red in a warning condition. In addition or in the alternative, the processor may govern light strips 4 on outer shell 1 to illuminate an area around helmet 100, optionally in response to light levels detected through camera 5, or to indicate a status of the helmet by the color or pattern of illumination. Electronic connectors 15 defined in a recess in helmet 100, either in outer shell 1 or in inner shell 2 as illustrated, can be used to establish wired connection between the processor and external devices or to charge the helmet's battery. Electronic connectors 15 can be any type of port to which electronic cables can be operatively connected, with USB type A, B, and C ports, HDMI ports, and Thunderbolt ports being some specific examples. According to various examples, the processor may be controllable to execute certain functions by hardware controls that are part of helmet 100, hardware connected to electronic connectors 15, or wirelessly such as by a mobile application run on a smart device or computer in wireless communication with the helmet.

Camera 5 may be any type of camera compact enough for mounting to helmet 100 and suitable for communication with a digital processor. For example, camera 5 may be any type of digital camera, and in further examples may be generally alike to cameras known for use in smartphones. Camera 5 may include a single image acquisition unit or multiple image acquisition units that the processor may use in concert for depth perception. Further, helmet 100 may optionally include a light, mounted integrally with the camera 5, near the camera, or elsewhere on helmet 100 to shine at least generally in the same direction as the camera's field of view. The light may be activated independently of camera 5 to be usable both as a headlamp for the wearer and to provide better lighting for image acquisition.

Camera 5 is in communication with the processor and, though shown at a front and center point on outer shell 1 in FIG. 1, may be placed anywhere on helmet 100. When located on helmet 100 so as to be front facing and having a field of view matching or significantly overlapping with the wearer's field of view, camera 5 may send to the processor individual images or video that generally corresponds what the wearer of the helmet can observe. Though not illustrated, helmet 100 may also be equipped with a microphone in communication with the processor that cooperates with camera 5 to acquire what the wearer sees and hears for recording or real-time transmission to remote computers and users. The processor may optionally also be configured to receive voice commands through the microphone to, for example, turn any electronic features of helmet 100 on or off, execute functions such as placing a call, hanging up, or beginning or ending video recording, or to adjust operating settings.

The processor may output sound to enable audible communication to the wearer of helmet 100 as well. A headphone jack 11 may be used for sound output and, in addition or in the alternative, helmet 100 may include a speaker for sound output as well. Simultaneous audio input and acquisition enable the wearer to communicate with remote colleagues as if by telephone or an audio headset while the wearer's hands remain free. In further combination with video acquired by camera 5, the audio acquisition and output capabilities of helmet 100 can give remote colleagues much of the experience of being on-site alongside the wearer of the helmet without the need for any travel. A remote manager or supervisor could therefore use a computer or smart device in communication, sequentially or simultaneously, with multiple helmets 100 worn by different workers to efficiently observe progress and issue instructions across a site or multiple, separate sites. Processors of helmets 100 could also be used to enable voice communication between multiple helmet wearers through the helmets' audio capabilities. Helmets 100 may also be capable of video communication, with camera 5 footage of one helmet being shown on screen 9 or HUD lens 8 of another helmet.

Headphone jack 11 may additionally or alternatively be a microphone jack. For example, jack 11 may be both an audio-in and audio-out connector such that a removable headset with bother a microphone and headphones can be connected to the processor through the jack. Provision of a microphone jack on helmet 100 enables selective addition or removal of sound acquisition hardware, which may be preferred if the wearer is likely to be present for discussion of confidential information.

Screen 9 is any type of digital display, such as, for example, a liquid crystal display (“LCD”) or organic light emitting diode (“OLED”), and may be located on a back facing part of outer shell 1 as illustrated. Screen 9 serves as a point of interface that presents navigable menus enabling a user that the wearer can to turn any electronic features of helmet 100 on or off, including distribution of air, execute functions such as placing a call, hanging up, or beginning or ending video recording, adjust operating settings such as air flow rate, or to read emails and text messages. Though not illustrated, buttons may be placed anywhere on helmet 100 for interaction with the contents of screen 9 or for use in any other circumstance. Additionally or in the alternative, screen 9 may be a touch screen.

Helmet 100 may optionally be provided with haptic feedback features such as an eccentric rotating mass, piezoelectric actuator, or any other type of feedback device. The processor may control the haptic feedback features in response to touch interactions with screen 9 such that a wearer can use the screen while wearing helmet 100. Additionally or in the alternative, the processor may be configured to facilitate interactions with screen 9 can while helmet 100 is worn by displaying some indication of the contents of the screen and the wearer's inputs on HUD lens 8.

HUD lens 8 in the illustrated example is positioned for convenient reference by the wearer without obscuring the wearer's vision. As such, HUD lens 8 may either be any of the opaque display types that may be used for screen 9 or transparent displays, such as, for example those enabled by transparent LCD, transparent OLED, or light reflection or projection technologies. Regardless of whether HUD lens 8 is a transparent or opaque display, the processor may be configured to use the HUD lens to show the wearer operating settings or status of helmet 100 related to operation of helmet's 100 air distribution system or otherwise, notifications of incoming our outgoing calls, information about inputs to controls of the helmet or interactions with screen 9, job status or instructions, emails or text messages, or any other information that might be useful to the wearer. In examples where HUD lens 8 is a transparent display, the processor may be configured to use the HUD lens in cooperation with camera 5 for augmented reality functions. In some examples wherein HUD lens 8 is a transparent display, the HUD lens can be larger or more centrally positioned than the illustrated example without blocking the wearer's vision.

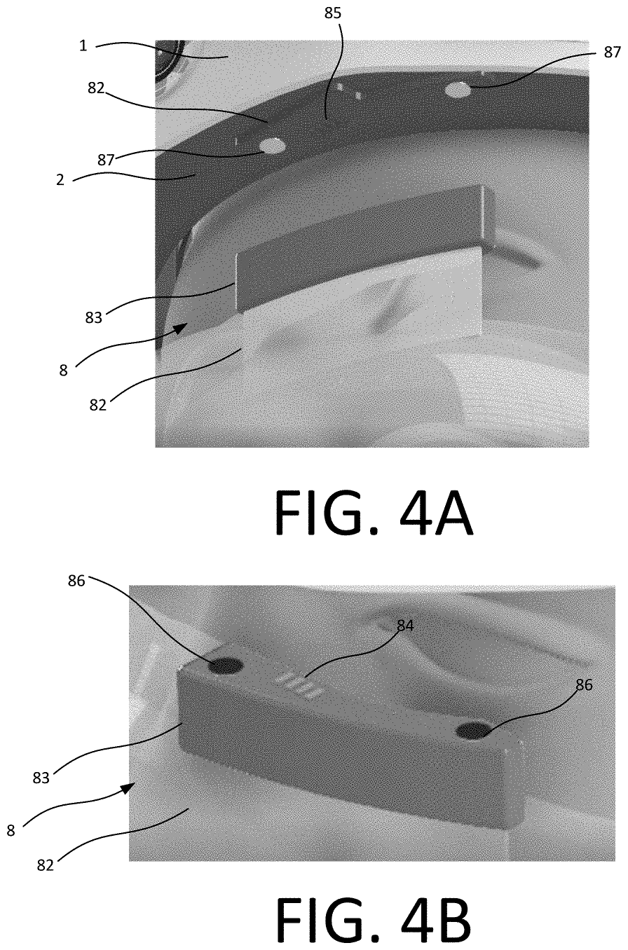

As shown in FIGS. 4A and 4B, HUD lens 8 of the illustrated example is removably connected to the helmet 100 at a bezel 81 on inner shell 2, though in other arrangements, the HUD lens may be permanently connected to the helmet or the bezel may be disposed on outer shell or another part of the helmet. HUD lens 8 includes a display 82 and a housing 83 to which the display is connected. Housing 83 holds electronic components of HUD lens 8 and includes housing contacts 84 that are complementary to bezel contacts 85 to enable electronic communication between the HUD lens and helmet 100. Housing 83 is securable to bezel 81 by any releasable feature, such as, for example, housing magnets 86 within the housing and bezel magnets 87 within the bezel.

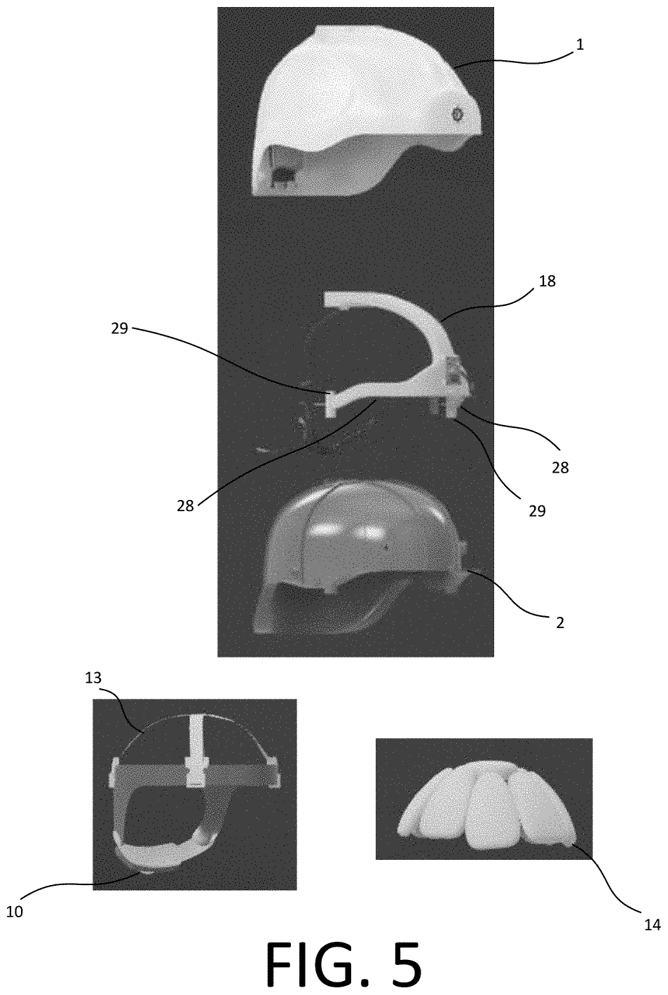

FIG. 5 shows structural components of helmet 100 according to the illustrated example in an exploded arrangement. Inner shell 1 and outer shell 2 are shaped complementarily to one another such that the inner shell can nest within the outer shell to jointly form a dome of helmet 100. The two-shell arrangement provides an additional layer of impact resistance to protect the wearer and creates an enclosed space between shells 1, 2 that can securely house an air distribution system, wiring, and electronic and computing components of helmet 100, including the processor. Shells 1, 2 may be fastened together such that the shells can be separated by loosening or removing the fasteners to access electronics housed between the shells.

Shells 1, 2 are supported by a suspension 13 alike to typical hard hat suspension systems. Suspension 13 is disposed inside connected to inner shell 2 and has a tightening knob 10 at the back. Shells 1, 2 and suspension 13 of the illustrated example are constructed from plastics, with shells being constructed from a more rigid plastic than suspension 13. However, shells 1, 2 can be constructed of any suitably rigid and durable material, including metal, and suspension 13 can be constructed from any suitably flexible and resilient material, including thick fabric. In some examples, either or both of outer shell 1 and inner shell 2 is constructed from a polycarbonate covering over expanded polystyrene foam. In other examples, outer shell 1 and inner shell 2 are both polycarbonate layers and the space between the shells is filled with expanded polystyrene foam, except for some cavities provided for electronics and the air distribution system.

Shells 1, 2 are also supported by a modular group of pads 14, which may be made from any soft material such as, for example, foam or fabric, received inside inner shell 2. Each pad 14 is independently removable and replaceable which facilitates cleaning and enables a wearer to select pads of differing shapes and sizes and wear the pads in a preferred arrangement. Removable attachment can be achieved by any of a variety of connectors, such as magnets in pads 14 and inner shell 12, or patches for hook and loop connections between the pads and inner shell. In hook and loop examples, hook patches may be either on the interior surface of inner shell 2 or on pads 14, and the loop patches may be located on the opposite of the inner shell or pads from whichever of the two the hook patches are located upon. Shells 1, 2, suspension 13, and pads 14 in various examples of helmet 100 may configured to satisfy any desired helmet or hardhat safety and construction standard. For example, helmet 100 of the illustrated arrangement is constructed to satisfy OSHA Standard 1926.100(b). However, the features and functions described herein with regard to helmet 100 are useful in contexts other than the kinds of industrial worksites where OSHA standard hard hats are needed, so it is envisioned that helmets according to other examples could be configured as motorcycle helmets, flight helmets, or sporting helmets. Further, depending on the construction of other parts of helmet 100, any one or any combination of inner shell 2, suspension 13, and pads 14 may be omitted from certain alternative designs.

Turning to FIG. 6, the air distribution system may include ductwork in any shape, but in the illustrated example the air distribution system includes a central conduit 18 extending down and forward from air intake 3 to two lateral conduits 28 that extend in opposite directions from one another across equal to or about half of a perimeter of helmet 100 and feed into mask connections 29. Central conduit 18 and lateral conduits 28 may also optionally feed into air supply holes in inner shell 2 to cool the wearer. However, perforations in inner shell 2 are incompatible with safety standards applicable to helmets for certain purposes. As such, examples of helmet 100 intended to comply with these standards do not have holes through inner shell 2 for communicating air from central conduit 18 or lateral conduits 28 to the user's head. In some such examples of helmet 100, the air distribution system supplies clean air to the wearer's face, but does not otherwise cool the wearer. In examples wherein air is distributed both to breathing mask 6 and through inner shell 2, and in examples wherein air is only delivered through breathing mask 6, the air distribution system, including impeller 19, may be governed to deliver air at a rate that increases with increasing temperature measured from either or both of the wearer and ambient air such that increased airflow can cool the wearer.

In the illustrated example, conduits 18, 28 are disposed within a space defined between inner shell 2 and outer shell 1 and fastened to inner shell 2 when helmet 100 is in an assembled state. Thus, if any filler material, such as padding or foam, is used to fill the space between inner shell 2 and outer shell 1, gaps are made in such filler material to accommodate conduits 18, 28. Conduits 18, 28 may be held in place by such filler material instead of fasteners in some arrangements. In further alternative arrangements, conduits 18, 28 may be disposed partially or entirely outside of outer shell 1 or inside of inner shell 2 and fastened to either or both of inner shell 2 and outer shell 1. If conduits 18, 28 extend within inner shell 2, conduits 18, 28 may optionally include holes for blowing air directly on the wearer for cooling purposes. However, holes for blowing air directly onto the wearer, except as routed through breathing mask 6, may be excluded in examples wherein inner shell 2 is constructed without holes or perforations so as to prioritize strength of inner shell 2 or compliance with certain safety standards.

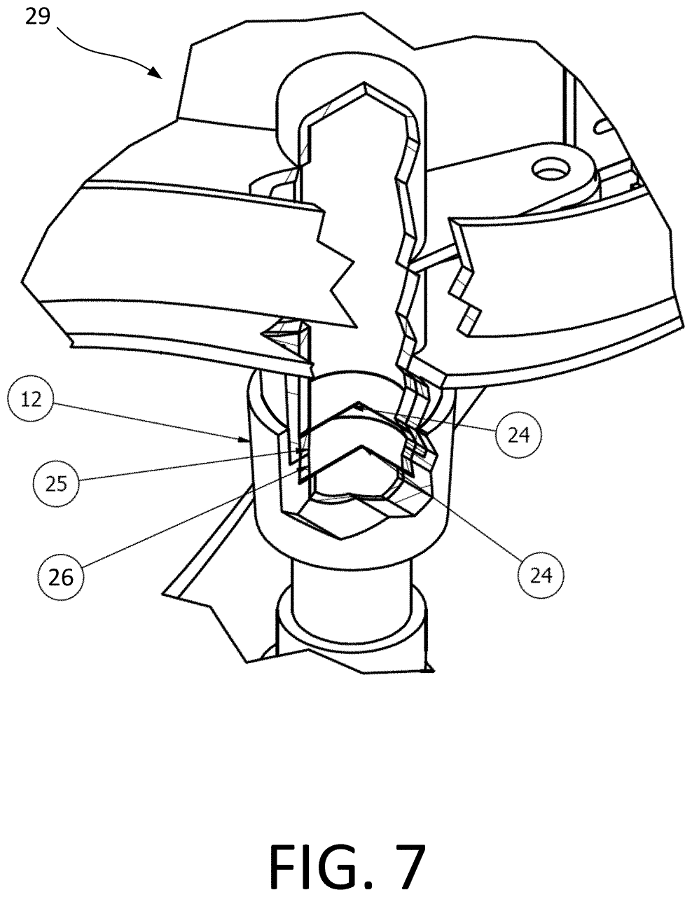

As shown in FIG. 7, mask connections 29 extend through inner shell 2 to allow for removable connection of breathing mask 6 to the air distribution system. Mask connections 29 include releasable connecting features that are complementary to features on breathing mask 6. The connecting features may be of any variety capable of establishing severable connection fluid connection between the respective air distribution systems of helmet 100 and breathing mask 6, but in the example illustrated in FIG. 7, each mask connection 29 includes a helmet side ring magnet 25 complementary to a mask side ring magnet 26. Ring magnets 25, 26 cooperate to form a passage for air between helmet 100 and breathing mask 6 when allowed to snap together. A collar 12 around each mask side ring magnet 26 receives a corresponding one of the mask connections 29 to align magnets 25, 26 with each other. In some alternative examples, collar 12 is instead a part of mask connection 29 configured to receive a corresponding tube portion of breathing mask 6.

An example alternative feature for establishing releasable fluid communication between helmet 100 and breathing mask 6 is an annular gasket in either of mask connection 29 or collar 12 that could receive and frictionally retain a corresponding tube portion of the other of the mask connection and the collar. Regardless of the type of connecting feature, either or both of mask connection 29 and collar 12 can include a debris filter 24 extending across a respective airway thereof as illustrated to prevent debris and contaminants from entering the airways of helmet 100 or breathing mask 6 when the breathing mask is not connected to the helmet. Debris filters 24 may be replaceable, such as by temporarily removing the respective ring magnet 25, 26 to enable removal of an old debris filter 24.

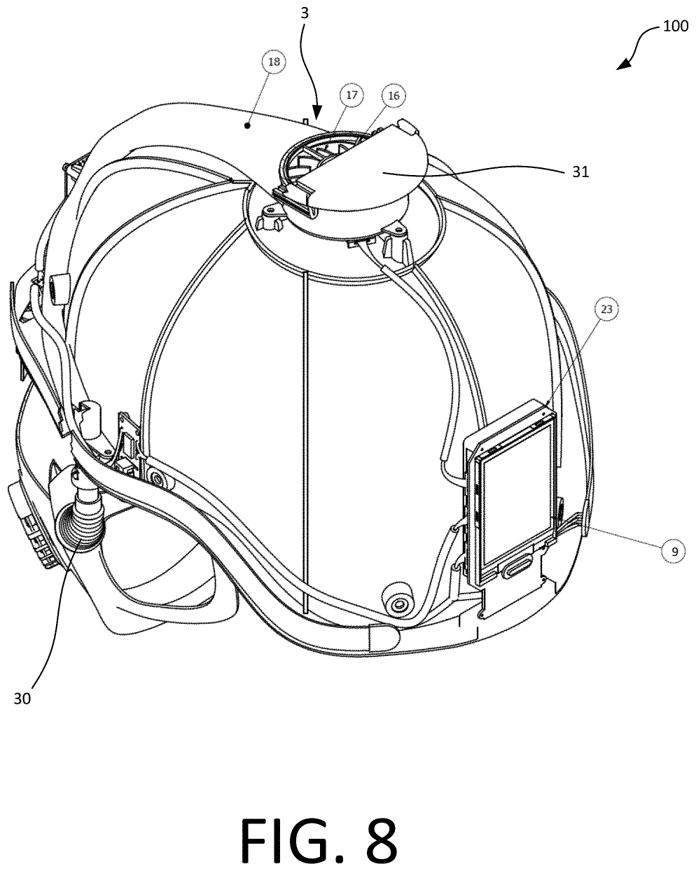

With reference to FIGS. 6 and 8, the connecting features of breathing mask 6 are disposed at ends of mask conduits 30, which may be either rigid or flexible, such as the accordion-type flexible conduits in the illustrated example. Mask conduits 30 conduct air to apertures 27 on the interior of breathing mask 6 so as to fill a space defined behind a face covering portion of the breathing mask with air supplied through the air distribution system of helmet 100. The face covering portion of breathing mask 6 is an air-impermeable piece structured and located so as to cover at least the wearer's mouth and nose. The modular nature of breathing mask 6 according to the illustrated example enables masks of different shapes and sizes to be applied to helmet 100 so that a mask having a face covering portion that fits comfortably may be selected and attached. Breathing mask 6 may further include one-way valves 7 through which air may exit, but not enter, the breathing mask. The wearer can therefore breathe naturally from a steady supply of air from helmet's 100 air distribution system and any exhaled air or excess supply air will exit breathing mask 6 through valves 7. Valves 7 may optionally also include filtered to, for example, catch any pathogens from the wearer's exhalations. Perimeter portions of breathing mask 6 may optionally be provided with flexible elements made from, for example, rubber, soft plastic, or other sealing material, that could seal against the wearer's face to prevent outside air from infiltrating the mask, but air can be supplied to the mask at high enough pressure to effectively prevent such infiltration. Air supply through breathing mask 6 of 1 or 2 cubic feet per minute (CFM) is usually sufficient to allow a wearer to breath freely and prevent infiltration of unfiltered air around the edges of breathing mask 6. According to various examples, helmet 100 can be configured to deliver filtered air through breathing mask 6 at a fixed rate of 1 or 2 CFM or to deliver air at a user adjustable rate. Adjustment may variously be accomplished by a smart phone app, interaction with screen 9, other controls on helmet 100, or peripheral controls connectable to helmet 100. Example adjustable airflow ranges include from zero to 1, 2, 3, or 4 CFM.

Air intake 3 receives air through an opening in outer shell 1 and includes an impeller 19 positioned adjacent to, and, optionally, downstream of, filter holder 16 that can retain an impeller filter 17. Impeller 19, which may be either an inline or centrifugal fan-style impeller, is rotationally driven to pull air through air intake 3 and force the air through the air distribution system. A lid 31 may extend across a majority of the opening in outer shell 1 at which air intake 3 is defined while leaving a relatively small gap around the edge of lid 31 through which air may pass, as shown in the illustrated example, to keep out precipitation and large debris. Lid 31 thus acts as a first stage or coarse filter upstream of impeller filter 17, and impeller filter 17 acts as second stage or fine filter. Here, “coarse” and “fine” refer to lesser and greater filtering capabilities, respectively, such that lid 31 will prevent relatively large objects or contaminants from reaching impeller filter 17, and impeller filter 17 will filter contaminants that are small enough to pass by lid 31. Lid 31 is removable and replaceable within outer shell 1 so as to enable access to filter holder 16 for removal and replacement of impeller filter 17. Lid 31 of the illustrated example includes flexible tabs 31 that snap into and out of engagement with outer shell 1, though in alternative arrangements the removability of lid 31 may be provided by any other type of releasable engagement, such as threads for engaging corresponding threads that may be provided on outer shell 1. Impeller filter 17 can be any type of air filter suitable for small-scale applications, including any of the filter materials used in passive face masks or surgical masks or any of the filter materials known for use in gas masks. In some examples, impeller filter 17 may be made from any of the materials used in the construction of respirators meeting the NIOSH N95 standard.

Filter holder 16 and impeller filter 17 can be respectively designed such that little or no air can enter helmet's 100 air distribution system through air intake 3 except through the impeller filter. Air intake 3 can therefore filter air more effectively than typical passive face masks, which rarely fit a wearer's face perfectly and therefore tend to allow some air to enter or escape around the edges.

Breathing mask 6 in combination with air intake 3 and air distribution system can provide multiple differences in function over a typical passive breathing mask that have utility on a worksite. The positive air pressure and relatively thorough filtration provided by air intake 3 give the wearer a steady supply of clean air. Such clean air supply can be relied on to impede the spread of respiratory infections between workers sharing any space, but worksites where hardhats are typically required are particularly likely to have unpleasant or even hazardous fumes, dust, and other air contaminants from which helmet's 100 air filtration and supply can protect the wearer.

In some examples, a face covering portion of breathing mask 6 can be made from transparent material so that the wearer's facial expressions remain visible. The face covering portion of breathing mask 6 can also optionally be a relatively rigid material shaped to avoid contact with the wearer's face, except at some perimeter areas of the face covering portion, which wearers may find more comfortable for long term wear than clinging fabric masks.

Helmet 100 of the illustrated example includes multiple electronic components housed between outer shell 1 and inner shell 2 in wired communication with each other and certain external features of the helmet, though in other examples any such electronic components could be located anywhere on the helmet and could be in any kind of communication with one another. Referring to FIG. 6 specifically, such electronic components include a camera module 20, HUD module 21, and headset module 22, for establishing communication between camera 5, HUD lens 8, and jack 11, respectively, and the processor.

Turning to FIG. 8, controller module 23 provides a main housing for electronic components of helmet 100, such as any one or any combination of the above described processor, memory, and battery. Controller module 23 may also provide support to screen 9. Electronic connectors 15 described above and shown in FIG. 2 extend through the housing of controller module 23 such that electronic connectors 15 are points of access for connecting power cables, USB devices, or other external components to the processor, battery, or other electronics housed within controller module 23. Through electronic connectors 15, external control devices, such as keyboards and mice, external storage, or external displays can be connected to the processor and memory housed in controller module 23. Connected control devices can be used to facilitate interactions with the processor that the on-board controls of helmet 100 make inconvenient or impossible, and can be used in cooperation with screen 9 or an external display to make helmet 100 usable as a portable computer. External memory can be used to store information recorded by helmet, such as audio recordings, video footage, call records, or diagnostic in formation. Alternatively, external memory can be used to load software updates or worksite instructions onto helmet's 100 internal processor and memory. Thus, controller module 23 of the illustrated example acts as a housing and point of interface for many of helmet's 100 electronic features, though electronics may be distributed differently in other arrangements.

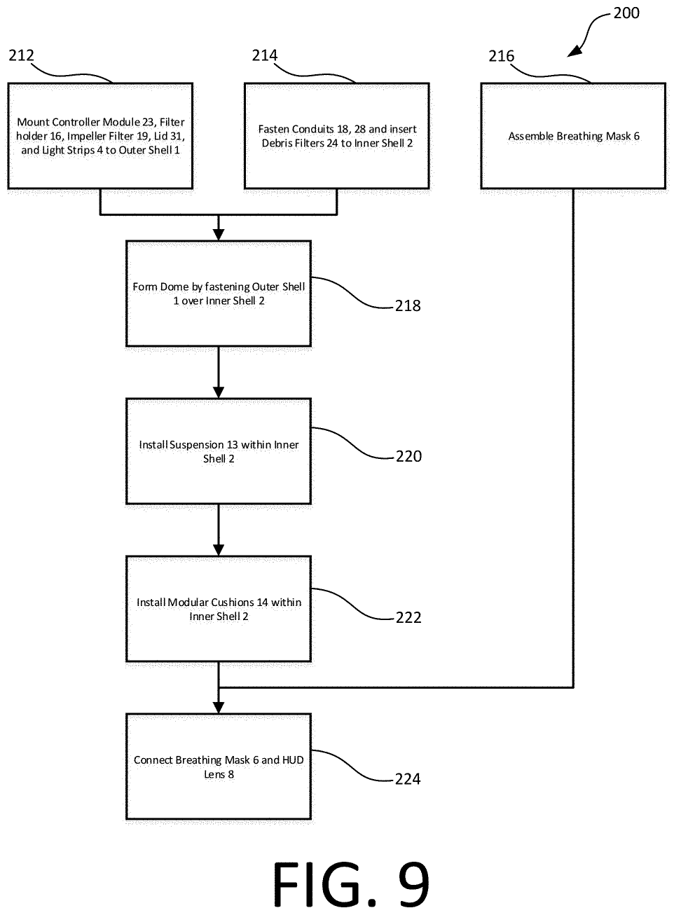

FIG. 9 shows a process 200 by which helmet 100 may be assembled. Outer shell 1 is prepared in step 212, wherein controller module 23 is mounted to outer shell 1. Filter holder 16, impeller filter 19, and lid 31 are deposited in the opening at the top of outer shell 1, and light strips 4 are installed on either side of outer shell 1. Inner shell 2 is prepared in step 214. Conduits 18, 28 are fastened to inner shell 2 and debris filters 24 are inserted behind helmet side ring magnets 25 in step 214. Breathing mask 6 is prepared in step 216. In step 216, debris filters 24 are inserted behind mask side ring magnets 26, valves 7 are assembled, and mask conduits 30 are connected to the face covering portion of breathing mask 6.

Following at least steps 212 and 214 of the foregoing, the dome of helmet 100 is formed by fastening the prepared outer shell 1 over the prepared inner shell 2 in step 218. The dome is further prepared for wearing by installation of suspension 13 within inner shell 2 in step 220 followed by placement of modular cushions 14 within inner shell 2 in step 222. Finally, breathing mask 6 as prepared in step 216 and HUD lens 8 are connected to the otherwise assembled helmet 100 in step 224.

The foregoing assembly process 200 as described above is merely an example, and the process 200 can be varied in several ways. The individual operations described within any of the steps of process 200 can be performed in generally any order. Moreover, in other examples, the steps themselves may be performed in different orders than that described above and shown in FIG. 9. For example, it is possible to install suspension 13 as in step 220 and install modular cushions 14 as in step 222 before preparing outer shell 1 as in step 212 or forming the dome by fastening outer shell 1 to inner shell 2 as in step 218. In further examples, any step may be only partially completed before another step starts, and any partially completed step may be completed during or after any later started step.

Although the concepts herein have been described with reference to particular arrangements, it is to be understood that these arrangements are merely illustrative of the principles and applications of the present disclosure. It is therefore to be understood that numerous modifications may be made to the illustrative arrangements and that other arrangements may be devised without departing from the spirit and scope of the present disclosure as defined by the appended claims.

1. A helmet comprising:
a dome;
an air distribution system extending within the dome and including a powered air intake defined at an opening in the dome; and
a breathing mask including a face covering portion behind which a space is defined and airways releasably connectable to the dome to establish fluid communication between the air distribution system and the space behind the face covering portion.

2. The helmet of claim 1, wherein the face covering portion of the mask includes a one way valve permitting air flow out of the space behind the face covering portion.

3. The helmet of claim 1, comprising an adjustable suspension system for suspending the dome relative to a wearer's head and wherein the dome includes a hard hat shell.

4. The helmet of claim 3, comprising wireless telecommunication hardware, a speaker, and a microphone.

5. The helmet of claim 4, comprising a front facing camera.

6. The helmet of claim 5, comprising a transparent HUD lens extending from a point of connection to the dome into a space corresponding to a field of view of a wearer of the helmet.

7. The helmet of claim 1, comprising a screen removably mounted to the dome outside of a space corresponding to a field of view of a wearer of the helmet.

8. The helmet of claim 1, comprising lights on an exterior of the dome and a thermometer configured to measure a temperature of a wearer of the helmet, wherein the lights are controlled to display a warning signal when the measured temperature exceeds a predetermined threshold.

9. The helmet of claim 1, wherein the mask is releas ably connectable to the dome at filtered outlet openings of the air distribution system.

10. The helmet of claim 1, wherein the mask includes filtered inlet openings for connection to the air distribution system.

11. The helmet of claim 1, wherein the face covering portion of the mask is rigid.

12. The helmet of claim 11, wherein the face covering portion of the mask is transparent.

13. The helmet of claim 1, wherein the air intake includes a holder for holding a replaceable air filter spanning an airway of the air intake.

14. The helmet of claim 13, wherein the holder is upstream of an impeller included by the air intake.

15. The helmet of claim 13, comprising a coarse filter upstream of the holder.

16. The helmet of claim 15, wherein the coarse filter is a lid extending across a majority of an opening in the dome through which the air intake is defined.

17. A helmet comprising:
a dome including an outer shell and an inner shell that are connected to one another so as to enclose an enclosed space between the outer shell and the inner shell;
an air distribution system including air conduits extending in the enclosed space, the air distribution system being configured to draw air into the conduits from outside the dome and to expel air out of the enclosed space; and
a face mask connected to the dome.

18. The helmet of claim 17, comprising lights on an exterior of the outer shell and a thermometer configured to measure a temperature of a wearer of the helmet, wherein the lights are controlled to display a warning signal when the measured temperature exceeds a predetermined threshold.

19. The helmet of claim 17, wherein the mask includes air conduits and is connected to the dome by releasable connections between the air conduits of the mask and the air conduits of the air distribution system.

20. The helmet of claim 17, comprising a coarse air filter and a fine air filter for the air distribution system.
